(19) United States
(12) Patent Application Publication
(10) Pub. No.: US 2015/0186628 A1
(43) Pub. Date: Jul. 2, 2015

(54) AUTHENTICATION WITH AN ELECTRONIC DEVICE

(71) Applicants: Isabel F. Bush, Portland, OR (US); Gregory A. Peek, North Plains, OR (US); Andy The Dude S. Idsinga, Portland, OR (US); Mark R. Francis, Portland, OR (US)

(72) Inventors: Isabel F. Bush, Portland, OR (US); Gregory A. Peek, North Plains, OR (US); Andy The Dude S. Idsinga, Portland, OR (US); Mark R. Francis, Portland, OR (US)

(21) Appl. No.: 14/141,948

(22) Filed: Dec. 27, 2013

(51) Int. Cl. G06F 21/31; G06F 21/32

(52) U.S. Cl. CPC G06F 21/31; G06F 21/32

(57) ABSTRACT

Techniques for user authentication are described herein. In one example, an electronic device may include logic, at least partially implemented in hardware, that can determine that the electronic device has received sensor data, the sensor data indicating the electronic device is to enter an activation state and detect authentication credentials in response to determining that the electronic device is to enter the activation state. The logic can also determine whether the authentication credentials are valid and grant access to the electronic device if the authentication credentials are valid. Additionally, the logic can deactivate the electronic device in response to a change in the sensor data.

### TECHNICAL FIELD

The present techniques relate generally to authentication and more particularly, but not exclusively, to authenticating a user for a computing device.

### BACKGROUND ART

Computers and other electronic devices, including personal computers, cellular phones, tablet computers, and portable and wearable devices, often store a user's personal information. Accordingly, these devices may incorporate certain security features including the capability to restrict access to information stored on the device, such as by requiring a user to enter a password or otherwise authenticate the user's identity before the information on the device can be accessed. Upon authentication, the device may also implement certain user preferences such as displaying a home screen that presents desired information to the user. However, some users may find that authenticating their identity each time the user wishes to access the device is tedious, and may therefore not take full and consistent advantage of the security features of the device.

### BRIEF DESCRIPTION OF THE DRAWINGS

FIG. 1 is a block diagram of an electronic device that can authenticate a user;

FIG. 2 is a process flow diagram of one embodiment of a method for user authentication;

FIG. 3 is a perspective view of one embodiment of a wearable electronic device that implements user enrollment and user authentication;

FIG. 4 is a process flow diagram of one embodiment of a method for user enrollment; and

FIG. 5 is a block diagram depicting an example of a tangible, non-transitory computer-readable medium that can authenticate a user.

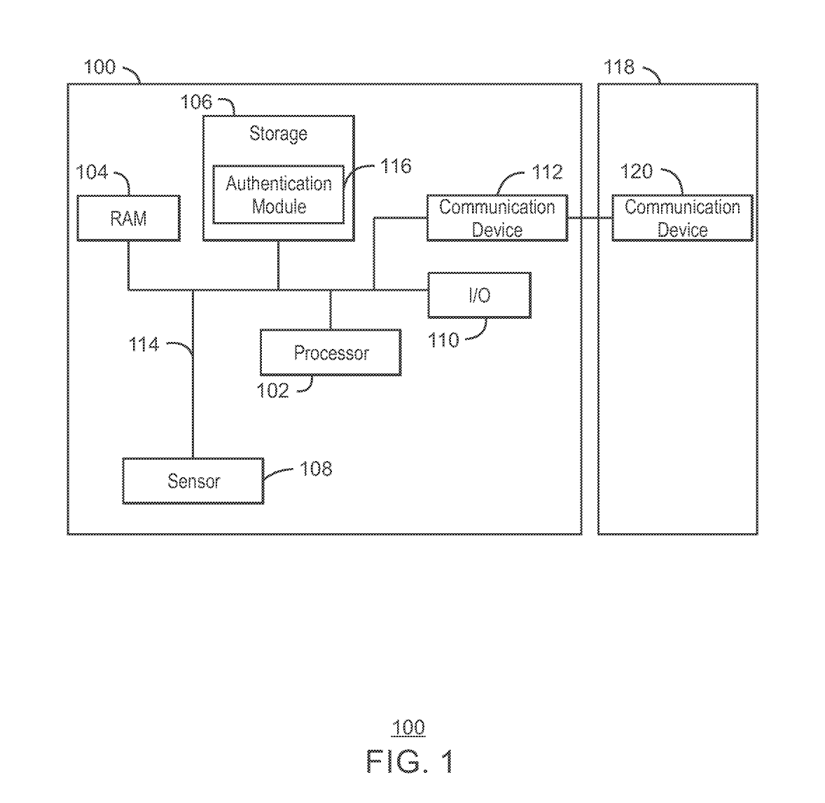

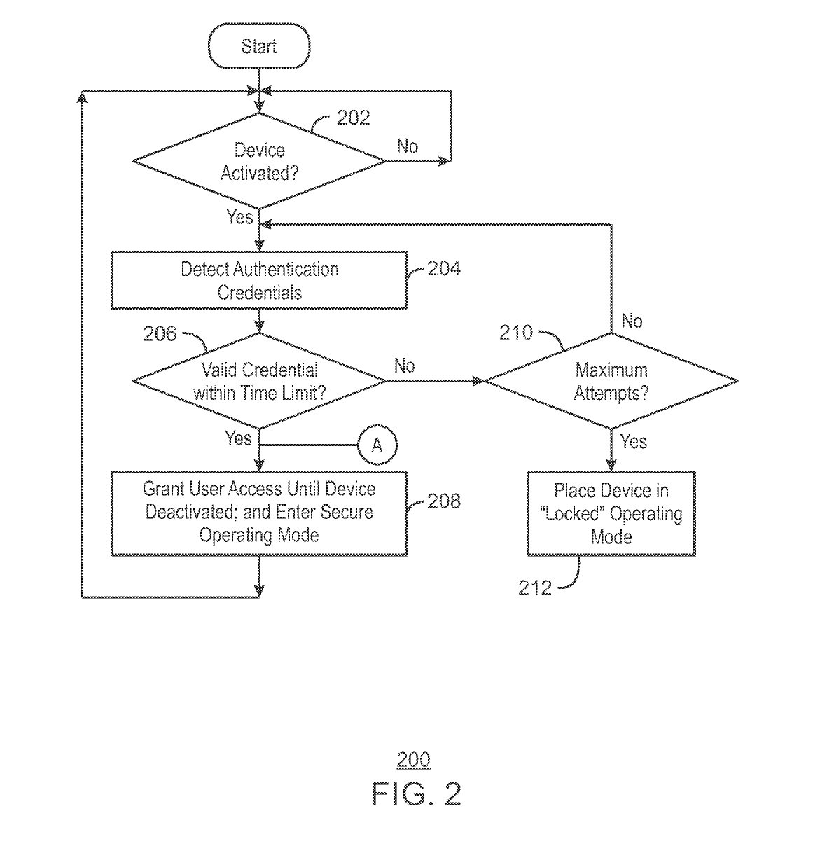

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an electronic device 100 that includes a user authentication capability in accordance with embodiments described herein. Electronic device 100 may be a computer, laptop, tablet, cellular or mobile phone, portable media or music player, a wearable device such as a smart watch or other smart device worn on, attached to, or otherwise associated with a user, or any other type of electronic device. Electronic device 100 includes central processing unit (CPU) 102, random access memory (RAM) 104, storage 106, one or more sensors 108, input/output (I/O) device 110, and communication device 112, all of which are communicatively coupled to and may exchange signals/information via device bus 114.

CPU (also referred to herein as processor) 102 may, in embodiments, be a conventional CPU or, in other embodiments, may be a CPU specifically configured for use in mobile or portable devices and may operate at low or reduced power consumption rates. CPU 102 is capable of reading and executing computer-readable instructions, which, in embodiments, may include instructions from the authentication module 116 stored in storage 106. RAM 104 may store various computer-readable instructions that are also executable by CPU 102, and may also store other data such as application-related data. Storage 106 may include a hard drive, an optical drive, a USB flash drive, an array of drives, or any combinations thereof, and may store the operating system, and other instructions, including authentication module 116, executable by CPU 102 of electronic device 100.

In some embodiments, sensor 108, which may include one or more sensors, can be any suitable type of sensor, including, without limitation, a microphone, light, accelerometer, gyroscope, camera, temperature, magnetic or hall effect, capacitive, heartbeat, vein, or similar sensor. Input/output (I/O) device 110 enables a user to input data to and receive information from the electronic device 100. The I/O device 110 may be configured as, for example, a touch screen display, keyboard and display combination, voice control and recognition system, speaker, or any combination of one or more of the foregoing, among others. Communication device 112 may be configured as a conventional communication (I/O) port, such as a USB port, or may be configured as a wireless I/O port, such as, for example, a WiFi or Bluetooth® port, that enables electronic device 100 to exchange information wirelessly with another device. Device bus 114 may be a conventional bus that carries electronic signals and data between and among the components of device 100, and, in embodiments, may be configured as a bus for use in mobile or portable devices.

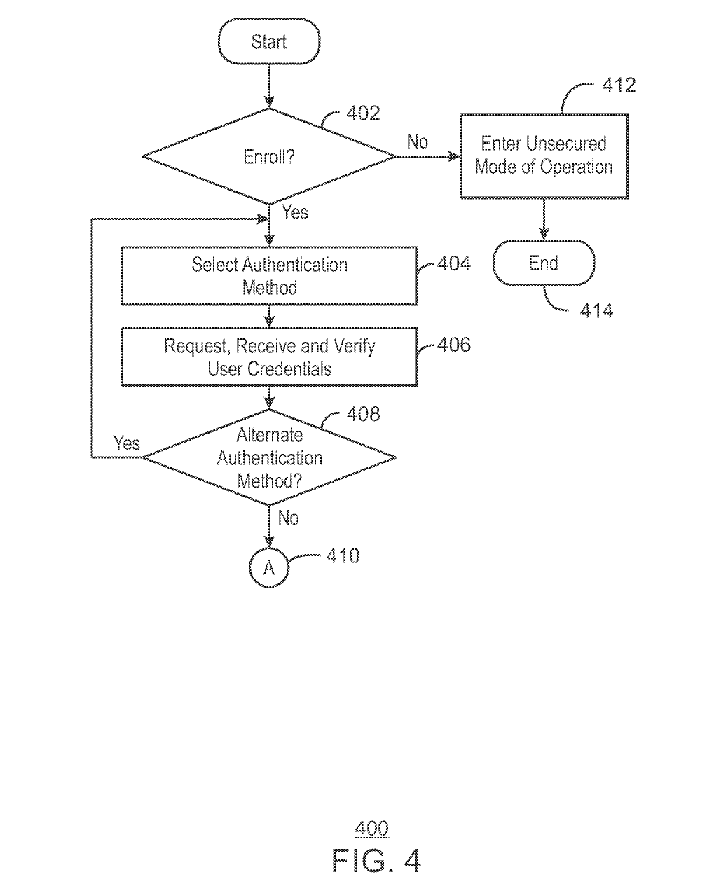

As will be more particularly described with reference to FIGS. 2 and 4 below, electronic device 100, and more particularly authentication module 116 executed by CPU 102 in conjunction with sensor 108 and I/O device 110, can authenticate and grant a user access to electronic device 100. The authentication module 116 may, in alternate embodiments, authenticate and grant a user access to a separate electronic device 118, such as a computer, laptop, tablet, cellular or mobile phone, portable media or music player, or a wearable device, among others. Electronic devices 100 and 118 may be communicatively coupled, such as, for example, wirelessly via Bluetooth® connection or a hard wired connection such as via a local area network or other direct connection, utilizing communication device 112 and a corresponding communication device 120 on electronic device 118.

It is to be understood that the block diagram of FIG. 1 is not intended to indicate that the electronic device 100 is to include all of the components shown in FIG. 1. Rather, the electronic device 100 can include fewer or additional components not illustrated in FIG. 1 (e.g., additional memory components, embedded controllers, additional modules, additional network interfaces, etc.). Furthermore, any of the functionalities of the authentication module 116 may be partially, or entirely, implemented in hardware and/or in the processor 102. In some embodiments, the functionalities of the authentication module 116 can be implemented with logic, wherein the logic, as referred to herein, can include any suitable hardware (e.g., a processor, among others), software (e.g., an application, among others), firmware, or any suitable combination of hardware, software, and firmware.

FIG. 2 is a process flow diagram for one embodiment of a method for user authentication in an electronic device. In some embodiments, the method 200 can be implemented with any suitable computing device, such as the electronic device 100 of FIG. 1. For the purposes of method 200, it should be noted that the electronic device may have been previously placed in a secured mode of operation via a user enrollment process that will be described in more detail below with reference to FIG. 4. In the secured mode of operation, the user can enter valid authentication credentials in order to access the device.

At block 202, the authentication module 116 can determine that the electronic device has received sensor data, the sensor data indicating the electronic device is to enter an activation state. Sensor data, as referred to herein, can include any data detected by a sensor, such as sensor 108 of FIG. 1. In some examples, the sensor data can indicate that the operating environment of the electronic device has changed. For example, sensor data may include data detected by a gyrometer, an accelerometer, or a compass, among others, that indicate the electronic device has changed location or orientation. In some examples, an activation state can include any state of the electronic device that causes the electronic device to transition from an inactive, standby, or hibernate mode of operation to an active mode of operation.

In some embodiments, the sensor data may include data indicating a distance between a body of a user and the electronic device is below a threshold. For example, sensor data may indicate that an electronic device is in close proximity to the body of a user. In some examples, the sensor data can include data related to a closing of a clasp of the electronic device, sensing a proximity of the device to the body of the user, sensing a temperature indicative of the device being associated with the body of the user, or sensing a heartbeat of the user, among others. If, at block 202, the authentication module 116 determines that the electronic device has not entered an activation state, the authentication module 116 continues to monitor whether the electronic device is to enter an activation state at block 202. If the authentication module 116 determines that the electronic device is to enter an activation state, method 200 continues at block 204.

At block 204, the authentication module 116 can detect authentication credentials in response to determining that the electronic device is to enter the activation state. In embodiments, authentication credentials may be requested and received by one or more interfaces or interface devices of the electronic device, such as, for example, via input/output (I/O) device 110 of electronic device 100. In embodiments, the electronic device, upon entering an activation state, may display or announce a message, vibrate, emit a sound, or otherwise request the user to provide credentials, such as, for example, by displaying a message through I/O device 110 of electronic device 100. At block 204, the authentication module 116 may provide an option to select the method by which authentication credentials are to be provided. In embodiments, the user may select one of several possible supported techniques for entering authentication credentials, such as, for example, inputting an alphanumeric passcode, speaking a pass phrase of one or more words, fingerprint matching, by one or more active techniques such as moving the device in a predetermined manner or pattern, or by one or more passive methods such as facial recognition, vein pattern or gait matching, or the like. The electronic device may, in embodiments, receive authentication credentials via a touch screen, keyboard, microphone, or other input method, such as, for example, by the user entering a password or pattern using I/O device 110 of electronic device 100. In some examples, detecting authentication credentials may include prompting the user to enter credentials, and receiving the credentials within a predetermined time limit.

In some embodiments, the authentication module 116 can detect authentication credentials from passive sensor data. Passive sensor data, as referred to herein, includes any data collected by a sensor without prompting a user for input. For example, passive sensor data may include data collected by a gait sensor, or an electrocardiogram sensor, among others. In some embodiments, a computing device can continuously monitor passive sensor data for authentication credentials after a computing device enters an activation state. For example, the authentication module 116 may, in response to entering an activation state, monitor passive sensor data that matches an authorized user. In some examples, the authentication module 116 can compare the gait, heart rate, facial features, or any other suitable passive sensor data to passive sensor data for an authorized user.

At block 206, the authentication module 116 can determine whether the detected authentication credentials are valid. The authentication module 116 may validate the authentication credentials by comparing the detected credentials with previously established or anticipated credentials, and may include verifying a pass code, verifying a voice match, voice or speech recognition, verifying a gait match, verifying any suitable biometric or gesture, or any combination of the foregoing, among others. In some embodiments, the authentication module 116 can determine if the detected authentication credentials are within a range of the anticipated credentials. For example, the authentication module 116 can determine if the difference between the sensor data and the anticipated credentials exceeds a threshold value. If the difference between the sensor data and the anticipated credentials exceeds a threshold, the sensor data may indicate invalid authentication credentials. If the difference between the sensor data and the anticipated credentials is below the threshold, the sensor data may indicate valid authentication credentials. If the detected authentication credentials are determined at block 206 to be invalid, method 200 proceeds to block 210. If the detected authentication credentials are determined at block 206 to be valid, method 200 proceeds to block 208.

At block 208, the authentication module 116 can grant access to the full functionality of, and any data stored on, the device until such time as the electronic device becomes deactivated. Thus, at block 208 the device is placed in an active and secure operating mode wherein, upon the device becoming deactivated, the authentication module 116 may request authentication credentials in order to access the device functionality and data. In some embodiments, the authentication module 116 can deactivate the electronic device in response to a change in the sensor data. For example the authentication module 116 may cause a computing device to enter a deactivated state when a change in sensor data is detected from the sensor that indicated the computing device was to enter the activation state. In some examples, the authentication module 116 may detect that a computing device is to enter an activation state when a sensor in a clasp indicates that the clasp has been closed. Opening the clasp can result in a change in the sensor data from the clasp, which can indicate that the authentication module 116 is to enter a deactivated state. In some embodiments, any other suitable change in sensor data can be used to indicate that a computing device is to transition to a deactivated state from an active state or an active state from a deactivated state.

In some embodiments, the authentication module 116 may detect that a computing device has transitioned to an inactive state rather than a deactivated state. An inactive state, as referred to herein, includes any state in which a computing device stops providing power to any suitable number of components or the computing device stops detecting sensor data from any number of sensors. A computing device may transition to an inactive state without entering a deactivated state. For example, in embodiments, a predetermined period of time during which the user has not interacted with the device may cause the device to enter an inactive operating condition or mode (e.g., a time out period). When the computing device transitions from an inactive state to an active state, the authentication module 116 may grant access to the functionality of the device without detecting authentication credentials if the computing device was never deactivated. If the device had been deactivated, authentication module 116 may detect authentication credentials on transitioning from an inactive to active state. Further, at block 208, the authentication module 116 may present information in a predetermined format based on the detected authentication credentials and previously-specified user preferences.

At block 210, the authentication module 116 can determine whether a predetermined number of attempts to enter valid authentication credentials have occurred without detecting valid authentication credentials. If the predetermined number of attempts has not occurred, method 200 proceeds to and repeats blocks 204, 206 and, if necessary, 210 until either valid authentication credentials are received or the number of attempts to enter valid authentication credentials has been reached. If the predetermined number of attempts has occurred method 200 proceeds to block 212. At block 212, the electronic device may be placed in a locked operating condition wherein the user may be given the options of entering an alternate authentication credential, initiating a secure reset of the authentication credentials, deleting user data from the computing device, contacting customer or user support, or the like.

The process flow diagram of FIG. 2 is not intended to indicate that the operations of the method 200 are to be executed in any particular order, or that all of the operations of the method 200 are to be included in every case. Additionally, the method 200 can include any suitable number of additional operations.

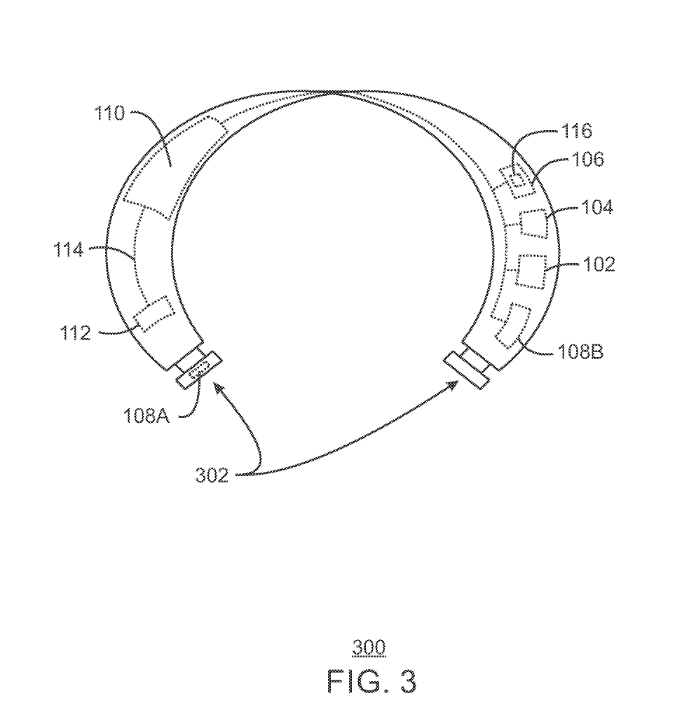

FIG. 3 is a perspective view of a wearable device implementing user authentication. Generally, device 300 can be configured to be worn upon or in close proximity to the body of a user. Device 300 may, for example, be configured as a band that is worn around the wrist, ankle, upper arm, or waist of a user. Device 300 may also, for example, be configured similar to a necklace and worn around the neck of a user, or as a headband worn around a user's head. Still further, device 300 may, for example, be configured similar to a cellular phone or Bluetooth® earpiece and worn on or about the ear of a user. Alternatively, device 300 may be configured to be clipped or otherwise attached to the clothing of a user, such as, for example, to a belt or otherwise attached to a user's clothing.

Device 300 includes central processing unit (CPU) 102, random access memory (RAM) 104, storage 106, sensors 108, and input/output (I/O) device 110, and communication device 112, all of which are communicatively coupled to and may exchange signals/information via device bus 114, each of which are described above in reference to FIG. 1. Device 300 may include two or more sensors 108A and 108B. Sensor 108A, in embodiments, may be associated or integrated into a clasp 302 of device 300 such that sensor 108A detects when a user closes the clasp to thereby associate device 300 with the user's body, and detects when a user opens the clasp to thereby remove the device 300 from the user's body. Upon opening and closing of the clasp, sensor 108A may issue a signal indicative of the opening and closing to CPU 102. Thus, sensor 108A may be utilized by method 200 to determine whether device 300 has been activated or is deactivated, and may in embodiments be utilized at block 202 of method 200 to determine in conjunction with authentication module 116 whether the electronic device 300 has been activated. As discussed above, the authentication module 116 may reside in storage 106. Sensor 108B may be virtually any type of sensor, including, without limitation, a microphone, accelerometer, camera, temperature, magnetic or hall effect, heartbeat, vein, or similar sensor. Thus, sensor 108B may, in embodiments, be utilized at block 206 of method 200 in conjunction with authentication module 116 and I/O device 110 to determine whether authentication credentials are valid. It should be noted that device 300 may, in embodiments, be configured without sensor 108A, and instead be configured without a clasp and associated sensor. In such an embodiment, sensor 108B may identify a potential activation of the device by sensing a proximity of device 300 to a body of a user via, for example, temperature, capacitance, light, or other sensing means.

FIG. 4 is a process flow diagram of one embodiment of a method for user enrollment. Generally, method 400 enables a user to establish and verify the authentication credentials for accessing an electronic device, such as electronic device 300. In embodiments, method 400 may be used to establish and verify the authentication credentials detected in the method 200 of FIG. 2 for user authentication. The method 400 may be embodied in computer executable instructions of an electronic device, such as authentication module 116 of electronic device 300 of FIG. 3.

At block 402, the authentication module 116 can prompt a user of the electronic device to enroll in the user authentication method by providing a message, such as, for example, displaying a textual message on a touch screen display of the device, issuing an announcement via a speaker of the device, and the like. In embodiments, the message may be issued via a user interface device, such as, for example, input/output (I/O) device 110 of devices 100 and 300. In some embodiments, the authentication module 116 can provide an enrollment option and an unsecured option. An enrollment option can indicate that the authentication module 116 is to detect authentication credentials that are to be used to enter a secured mode of operation. An unsecured option can indicate that the authentication module 116 is to enter an unsecured mode of operation without detecting authentication credentials. If the authentication module 116 detects an unsecured option, method 400 proceeds to block 412 and the electronic device may be caused to enter an unsecured mode of operation wherein no authentication credentials may be detected to access the device or its content, and method 400 ends at block 414. If the authentication module 116 detects an enrollment option, method 400 proceeds to block 404.

At block 404, the authentication module 116 can prompt a selection of a primary authentication technique if the enrollment option is selected. The primary authentication technique may include, for example, speaking, entering a pattern or alphanumeric pass code, retinal or facial recognition, or other biometric recognition. In embodiments, the electronic device may provide the user with a displayed or spoken menu of the available or supported authentication methods. The user may then select via a user interface the preferred primary authentication method. In embodiments, the user may utilize an interface device, such as I/O device 110 of devices 100 and 300 to select the preferred primary authentication method.

At block 406, the authentication module 116 can detect authentication credentials for the primary authentication technique, the authentication credentials enabling access to the computing device when the computing device transitions to an active state from a sleep, hibernate, or suspend mode of operation, or is otherwise inactive. An active state, as referred to herein, can include any state of an electronic device in which a processor can detect data from an I/O device, or hardware components in a computing device that do not receive power in an inactive state begin to receive power. If the authentication module 116 detects a pass code or pattern entry as the primary authentication method, the authentication module 116 may prompt a user to enter the pass code or pattern entry credentials via, for example, a touch screen of the device. In embodiments, the user may utilize an interface device, such as I/O device 110 of devices 100 and 300, that corresponds to the selected primary authentication technique to enter the credentials. Once the user has entered the credentials, the authentication module 116 may verify the authentication credentials by querying a user to enter the credentials a second time, by displaying the credentials to a user for confirmation, announcing the credentials to a user for confirmation, or by similar means. In embodiments, the authentication module 116 presents the authentication credentials to a user via an interface device, such as I/O device 110 of devices 100 and 300. Once the authentication credentials have been received and verified, method 400 proceeds to block 408.

At block 408, the authentication module 116 can provide an option of selecting an alternate authentication technique. Alternate authentication techniques may be used when the primary authentication technique may be susceptible to interference or may be difficult to utilize under certain circumstances, such as, for example, attempting to utilize a voice recognition authentication technique in a noisy environment. If the authentication module 116 detects that an alternate authentication technique is not selected, method 400 proceeds to block 410. If the authentication module 116 detects that an alternate authentication technique is selected, method 400 proceeds to block 404, and repeats blocks 404, 406 and 408 until such time as the authentication module 116 detects input indicating a decline to select an alternate authentication technique or no additional alternate authentication techniques are available at which time method 400 can proceed to block 410.

At block 410, or junction A, the enrollment process is complete and method 200 is invoked at the corresponding junction A of method 200 of FIG. 2. At block 208, the electronic device can enter the previously-described secured mode of operation and access is granted to the device until such time as the device becomes inactive.

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

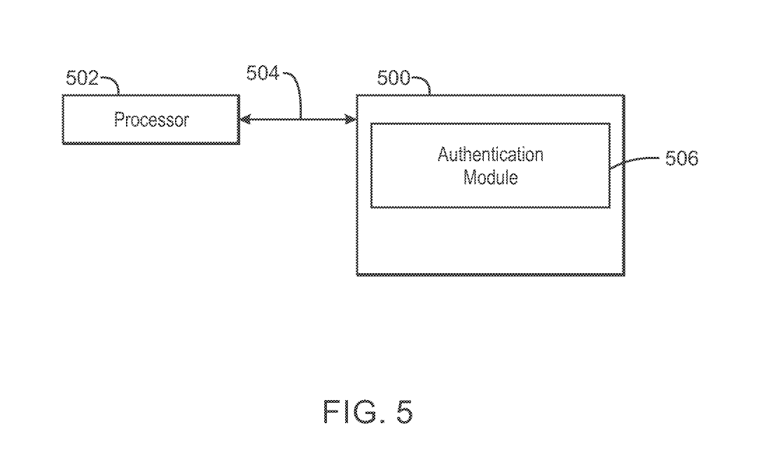

FIG. 5 is a block diagram depicting an example of a tangible, non-transitory computer-readable medium that can authenticate a user. The tangible, non-transitory, computer-readable medium 500 may be accessed by a processor 502 over a computer interconnect 504. Furthermore, the tangible, non-transitory, computer-readable medium 500 may include code to direct the processor 502 to perform the operations of the current method.

The various software components discussed herein may be stored on the tangible, non-transitory, computer-readable medium 500, as indicated in FIG. 5. For example, an authentication module 506 may be adapted to direct the processor 502 to determine that the electronic device has received sensor data, the sensor data indicating the electronic device is to enter an activation state. The authentication module 506 may also direct the processor to request authentication credentials in response to determining that the electronic device is to enter the activation state and determine whether the authentication credentials are valid. Furthermore, the authentication module 506 may also grant access to the electronic device if the authentication credentials are valid. It is to be understood that any number of additional software components not shown in FIG. 5 may be included within the tangible, non-transitory, computer-readable medium 500, depending on the specific application.

### Example 1

At least one non-transitory machine readable medium for user authentication having instructions stored therein that, in response to being executed on an electronic device, cause the electronic device to determine that the electronic device has received sensor data, the sensor data indicating the electronic device is to enter an activation state. The instructions can also cause the electronic device to detect authentication credentials in response to determining that the electronic device is to enter the activation state. In addition, the instructions can cause the electronic device to determine whether the authentication credentials are valid and grant access to the electronic device if the authentication credentials are valid.

In some embodiments, the sensor data comprises data related to a distance between a body of the user and the electronic device being below a threshold. Additionally, the sensor data may include data related to a closing of a clasp of the electronic device, sensing a proximity of the device to the body of the user, sensing a temperature indicative of the device being associated with the body of the user, or sensing a heartbeat of the user. In some examples, the instructions cause the electronic device to prompt the user to enter credentials, and receive the credentials within a predetermined time limit. For example, the instructions may cause the electronic device to detect authentication credentials by displaying or announcing a message, vibrating, emitting a sound, or any combination thereof. In some embodiments, the instructions cause the electronic device to detect the authentication credentials from passive sensor data.

In some embodiments, the instructions cause the electronic device to present an option to provide the authentication credentials by entering an alphanumeric pass code, speaking one or more words or sounds, presenting a biometric characteristic, or moving the device in a particular manner. In some examples, the instructions cause the electronic device to determine whether the authentication credentials match anticipated credentials or the authentication credentials are within a predetermined range of the anticipated credentials. In some embodiments, the instructions cause the electronic device to detect a transition from an inactive state to an active state, and grant access to the electronic device without detecting the authentication credentials. In some examples, the instructions cause the electronic device to grant access to the electronic device by displaying information in a predetermined format that corresponds to one of the authentication credentials and previously-specified user preferences. The instructions also cause the electronic device to detect that the electronic device is in a locked operating condition, the locked operating condition comprising presenting an option to select an alternate technique of authentication and corresponding alternate credentials, an option to reset the authentication credentials, or an option to request support.

### Example 2

An electronic device for user authentication is also described herein. The electronic device may include logic, at least partially implemented in hardware, that can determine that the electronic device has received sensor data, the sensor data indicating the electronic device is to enter an activation state and detect authentication credentials in response to determining that the electronic device is to enter the activation state. The logic can also determine whether the authentication credentials are valid and grant access to the electronic device if the authentication credentials are valid. Additionally, the logic can deactivate the electronic device in response to a change in the sensor data.

In some embodiments, the electronic device can also include a clasp operable to associate the electronic device with the body of the user, and a sensor to detect the sensor data indicating an opening and a closing of the clasp. In some examples, a closing of the clasp causes the logic to request authentication credentials. In some embodiments, the logic can also detect authentication credentials from passive sensor data that is collected when the electronic device enters the activation state. The logic can also present an option to select one of several techniques for providing the authentication credentials, the several techniques comprising entering an alphanumeric pass code, speaking one or more words or sounds, presenting a biometric characteristic, and moving the device in a particular manner.

### Example 3

At least one non-transitory machine readable medium having instructions for user enrollment stored therein that, in response to being executed on an electronic device, cause the electronic device to provide an enrollment option and an unsecured option in a computing device and enter an unsecured mode of operation in the computing device if the unsecured option is selected. The instructions can also cause the electronic device to prompt a selection of a primary authentication technique if the enrollment option is selected and detect authentication credentials for the primary authentication technique, the authentication credentials enabling access to the computing device when the computing device transitions to an active state from an inactive state. Additionally, the instructions can cause the electronic device to enter a secured mode of operation in the computing device upon detecting valid authentication credentials.

In some embodiments, the instructions cause the electronic device to provide the primary authentication technique and at least one alternate authentication technique. The instructions can also cause the electronic device to detect a selection of one or more alternate authentication techniques, and detect corresponding authentication credentials for each selected alternate authentication technique.

### Example 4

A system for user authentication is also described herein. The system may include one or more sensors to provide sensor data and logic, at least partially implemented in hardware, that can determine that an electronic device has received sensor data from the one or more sensors, the sensor data indicating the electronic device is to enter an activation state and detect authentication credentials in response to determining that the electronic device is to enter the activation state. The logic can also determine whether the authentication credentials are valid and grant access to the electronic device if the authentication credentials are valid. Additionally, the logic can deactivate the electronic device in response to a change in the sensor data.

In some embodiments, the system can also include a clasp operable to associate the electronic device with the body of the user, wherein the one or more sensors is to detect the sensor data indicating an opening and a closing of the clasp. In some examples, a closing of the clasp causes the logic to request authentication credentials. In some embodiments, the logic can also detect authentication credentials from passive sensor data that is collected when the electronic device enters the activation state. The logic can also present an option to select one of several techniques for providing the authentication credentials, the several techniques comprising entering an alphanumeric pass code, speaking one or more words or sounds, presenting a biometric characteristic, and moving the device in a particular manner.

It is to be understood that specifics in the aforementioned examples may be used anywhere in one or more embodiments. For instance, all optional features of exemplary devices described above may also be implemented with respect to any of the other exemplary devices and/or the method described herein. Furthermore, although flow diagrams and/or state diagrams may have been used herein to describe embodiments, the present techniques are not limited to those diagrams or to their corresponding descriptions. For example, the illustrated flow need not move through each box or state or in exactly the same order as depicted and described.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. At least one non-transitory machine readable medium for user authentication having instructions stored therein that, in response to being executed on an electronic device, cause the electronic device to:
determine that the electronic device has received sensor data, the sensor data indicating the electronic device is to enter an activation state;
detect authentication credentials in response to determining that the electronic device is to enter the activation state;
determine whether the authentication credentials are valid;
grant access to the electronic device if the authentication credentials are valid; and
deactivate the electronic device in response to a change in the sensor data.

2. The at least one non-transitory machine readable medium of claim 1, wherein the sensor data comprises data related to a distance between a body of the user and the electronic device being below a threshold.

3. The at least one non-transitory machine readable medium of claim 1, wherein the sensor data comprises data related to a closing of a clasp of the electronic device, sensing a proximity of the device to the body of the user, sensing a temperature indicative of the device being associated with the body of the user, or sensing a heartbeat of the user.

4. The at least one non-transitory machine readable medium of claim 1, wherein the instructions, in response to being executed on the electronic device, cause the electronic device to prompt a user to enter credentials, and receive the credentials within a predetermined time limit.

5. The at least one non-transitory machine readable medium of claim 4, wherein the instructions, in response to being executed on the electronic device, cause the electronic device to display or announce a message, vibrate, emit a sound, or any combination thereof.

6. The at least one non-transitory machine readable medium of claim 4, wherein the instructions, in response to being executed on the electronic device, cause the electronic device to detect the authentication credentials from passive sensor data.

7. The at least one non-transitory machine readable medium of claim 6, wherein the instructions, in response to being executed on the electronic device, cause the electronic device to present an option to provide the authentication credentials by entering an alphanumeric pass code, speaking one or more words or sounds, presenting a biometric characteristic, or moving the device in a particular manner.

8. The at least one non-transitory machine readable medium of claim 1, wherein the instructions, in response to being executed on the electronic device, cause the electronic device to determine whether the authentication credentials match anticipated credentials or the authentication credentials are within a predetermined range of the anticipated credentials.

9. The at least one non-transitory machine readable medium of claim 1, wherein the instructions, in response to being executed on the electronic device, cause the electronic device to:
detect a transition from an inactive state to an active state; and
grant access to the electronic device without detecting the authentication credentials if the device was never deactivated.

10. The at least one non-transitory machine readable medium of claim 9, wherein the instructions, in response to being executed on the electronic device, cause the electronic device to detect that the electronic device is in a locked operating condition, the locked operating condition comprising presenting an option to select an alternate technique of authentication and corresponding alternate credentials, an option to reset the authentication credentials, or an option to request support.

11. The at least one non-transitory machine readable medium of claim 1, wherein the instructions, in response to being executed on the electronic device, cause the electronic device to display information in a predetermined format that corresponds to one of the authentication credentials and previously-specified user preferences.

12. An electronic device for user authentication, comprising:
logic, at least partially implemented in hardware, to:
determine that the electronic device has received sensor data, the sensor data indicating the electronic device is to enter an activation state;
detect authentication credentials in response to determining that the electronic device is to enter the activation state;
determine whether the authentication credentials are valid;
grant access to the electronic device if the authentication credentials are valid; and
deactivate the electronic device in response to a change in the sensor data.

13. The electronic device of claim 12, further comprising a clasp operable to associate the electronic device with the body of the user, and a sensor to detect the sensor data indicating an opening and a closing of the clasp.

14. The electronic device of claim 13, wherein a closing of the clasp causes the logic to request authentication credentials.

15. The electronic device of claim 12, wherein the logic is to detect authentication credentials from passive sensor data that is collected when the electronic device enters the activation state.

16. The electronic device of claim 12, wherein the logic is to present an option to select one of several techniques for providing the authentication credentials, the several techniques comprising entering an alphanumeric pass code, speaking one or more words or sounds, presenting a biometric characteristic, and moving the device in a particular manner.

17. The electronic device of claim 13, wherein opening of the clasp or increasing distance between a device sensor and the body of the user causes the user's authentication credentials to be invalidated (device deactivated).

18. At least one non-transitory machine readable medium having instructions for user enrollment stored therein that, in response to being executed on an electronic device, cause the electronic device to:
provide an enrollment option and an unsecured option in a computing device;
enter an unsecured mode of operation in the computing device if the unsecured option is selected;
prompt a selection of a primary authentication technique if the enrollment option is selected;
detect authentication credentials for the primary authentication technique, the authentication credentials enabling access to the computing device when the computing device transitions to an active state from an inactive state; and
enter a secured mode of operation in the computing device upon detecting valid authentication credentials.

19. The at least one non-transitory machine readable medium of claim 18, wherein the instructions, in response to being executed on the electronic device, cause the electronic device to provide the primary authentication technique and at least one alternate authentication technique.

20. The at least one non-transitory machine readable medium of claim 19, wherein the instructions, in response to being executed on the electronic device, cause the electronic device to detect a selection of one or more alternate authentication techniques, and detect corresponding authentication credentials for each selected alternate authentication technique.

21. A system for user authentication, comprising:
one or more sensors to provide sensor data; and
logic, at least partially implemented in hardware, to:
determine that an electronic device has received sensor data from the one or more sensors, the sensor data indicating the electronic device is to enter an activation state;
detect authentication credentials in response to determining that the electronic device is to enter the activation state;
determine whether the authentication credentials are valid;
grant access to the electronic device if the authentication credentials are valid; and
deactivate the electronic device in response to a change in the sensor data.

22. The system of claim 21, further comprising a clasp operable to associate the electronic device with a body of a user, wherein the one or more sensors is to detect the sensor data indicating an opening and a closing of the clasp.

23. The system of claim 22, wherein a closing of the clasp causes the logic to request authentication credentials.

24. The system of claim 21, wherein the logic is to detect authentication credentials from passive sensor data that is collected when the electronic device enters the activation state.

25. The system of claim 21, wherein the logic is to present an option to select one of several techniques for providing the authentication credentials, the several techniques comprising entering an alphanumeric pass code, speaking one or more words or sounds, presenting a biometric characteristic, and moving the device in a particular manner.

26. The system of claim 22, wherein opening of the clasp or increasing distance between the one or more sensors and the body of the user causes the user's authentication credentials to be invalidated.
